(19) United States
(12) Patent Application Publication
(10) Pub. No.: US 2016/0001537 A1
(43) Pub. Date: Jan. 7, 2016

(54) ASSEMBLY SYSTEM

(71) Applicant: DESIGNERGY SA, Lugano (CH)

(72) Inventors: Massimo DE ROSSI, Castagnola (CH); Alessandro FORNARI, Corcagnano (PR) (IT)

(73) Assignee: DESIGNERGY SA, Lugano (CH)

(21) Appl. No.: 14/771,160

(22) PCT Filed: Feb. 25, 2014
(86) PCT No.: PCT/EP2014/053597

§ 371 Date: Aug. 27, 2015

(30) Foreign Application Priority Data
Feb. 28, 2013 (CH) 00521/13

(51) Int. Cl. B32B 37/12; B32B 38/18; B25J 15/06; B25J 9/00; B25J 15/00

(52) U.S. Cl. CPC B32B 37/1284; B25J 9/0096; B25J 15/0052; B25J 15/00; B25J 15/0616; B25J 15/0608; B32B 38/18; Y10S 901/31; Y10S 901/37; B32B 2038/1891; B32B 2457/12

(57) ABSTRACT

A system (1) and a method for assembling laminated structures utilising a robot (10) for collecting and placing sheet-shaped material, further utilising an adhesive applicator (13) which is collected from an adhesive applicator rest station (14) by the robot (10), is used to apply adhesive to the sheet-shaped material, and is then returned to the adhesive applicator rest station (14).

### RELATED APPLICATIONS

This application is a U.S. national phase application of International Application number PCT/EP2014/053597 filed Feb. 25, 2014 claiming priority of Switzerland application 00521/13 filed Feb. 28, 2013.

### TECHNICAL FIELD

The present invention relates to a method and system for assembling laminated structures from sheet-shaped material.

### BACKGROUND AND SUMMARY

Sheet-shaped or plate-shaped materials in general are materials which have a thickness significantly less than their length and breadth, and may be of constant thickness, or have varying thickness such as a wedge-shape. Such materials may be of rectilinear or curved form, or a combination of both.

In many automated industrial assembly situations for assembling laminated structures, it can be uneconomic to have a high degree of assembly robot specialisation due to the capital costs that procuring such highly specialised equipment entails. As such, it is often preferable to be able to utilise the same robot for multiple assembly steps, either in a serial production line or in piece-by-piece assembly.

In the present case of assembling laminated structures from sheet-shaped material, the same robot may be required to both position material, and to apply adhesive to the surface of the material, and then to position the next piece of material upon the first so as to form a laminated structure. However, merely integrating an adhesive applicator into the robot entails significant challenges. In the case of modern, highly adaptable assembly robots with multiple degrees of freedom, a significant length of adhesive conduit is required for non-self-contained adhesive applicators, which may impinge upon the movement of the robot, or may become entangled therein, becoming damaged. Furthermore, such a length of conduit contains a significant amount of adhesive, which leads to wastage. And finally, adhesive may drip from the adhesive applicator during movement of the robot, which may reduce the quality of the final product, or pollute the workplace. This latter can even be a problem with more simple robots with few degrees of freedom.

An object of the present invention is thus to overcome at least one of the above-mentioned disadvantages.

This object is achieved by a system for assembling laminated structures from sheet-shaped material according to the invention. The system comprises at least one material input station for providing sheet-shaped material. Such a material input station may be simply a table or support upon which sheet-shaped material is placed either manually or automatically, may be a rack arrangement in which multiple pieces of sheet-shaped material are mounted, or may simply be a stack of sheet-shaped material. Alternatively, the material input station may be a previous station, such as a work station, in a production assembly line. A work station for processing said sheet-shaped material is provided, which may be merely a table or support, or a more complicated arrangement e.g. involving a conveyor. An adhesive applicator arrangement comprising at least one adhesive applicator which may be stand-alone or connected to an adhesive reservoir e.g. by a hose, is provided, for applying adhesive to the sheet-shaped material, and an adhesive applicator rest station is provided for receiving the adhesive applicator. A robot which is movable on or about at least one axis, i.e. is a Cartesian, polar, or combined Cartesian and polar robot, is provided. This robot is adapted to be able to collect sheet-shaped material from the material input station and to deposit the sheet-shaped material at the work station. The robot is furthermore adapted to collect the adhesive applicator from the adhesive applicator rest station, to apply adhesive from said adhesive applicator to the sheet-shaped material deposited at said work station, particularly to the upper surface of the sheet-shaped material, and to return the adhesive applicator to the adhesive applicator rest station. In consequence, the same robot can be utilised for both collecting and positioning sheet-shape material, and for applying adhesive thereto, without requiring that an adhesive applicator be integrated into the robot, or to be permanently attached thereto. Thus, extensive and complicated hoses etc which may become tangled in the robot are no longer needed, and the risk of adhesive dripping from the adhesive applicator is limited to the area between the adhesive applicator rest station and the work station rather than to the entire area of movement of the robot.

In an embodiment of the system, the robot comprises a manipulation head which comprises a first manipulator for releasably holding the sheet-shaped material and a second manipulator for releasably holding the adhesive applicator. Thus a single manipulation head on the robot can handle both the sheet-shaped material and the adhesive applicator. The first manipulator and the second manipulator may each comprise at least one of: at least one gripper (i.e. with at least two opposed fingers or similar), at least one pneumatic suction cup, at least one electromagnet.

In an embodiment of the system, the adhesive applicator arrangement comprises an adhesive reservoir in operative connection with the adhesive applicator and comprises means for forcing adhesive towards the adhesive applicator. Thus continuous operation of the adhesive applicator can be assured. The aforementioned means for forcing adhesive towards the adhesive applicator may comprise at least one of: a pump, a piston arrangement, a pressurized gas arrangement, a gravity-feed arrangement.

In an embodiment of the system, the adhesive applicator rest station comprises a liquid reservoir for holding a quantity of a liquid agent, such as an anti-curing, anti-oxidation, or anti-drying agent, in contact with at least part of the adhesive applicator (i.e. at least the adhesive outlet) when the adhesive applicator is positioned in the adhesive applicator rest station. In consequence, undesired hardening or thickening of the adhesive in the adhesive applicator exposed to the air is avoided when the adhesive applicator is positioned in the adhesive applicator rest station.

In an embodiment of the system, the laminated structures referred to are building integrated photovoltaics, also known as Structurally Integrated Solar Building Elements, which comprise a photovoltaic panel and at least one structural element.

In an embodiment of the system, the sheet-shaped material comprises a photovoltaic panel and at least one structural element.

An object of the invention is likewise attained by a method for assembling laminated structures from sheet-shaped material, the method comprising the steps of:
providing sheet-shaped material at at least one material input station. Such a material input station may be simply a table or support upon which sheet-shaped material is placed either manually or automatically, may be a rack arrangement in which multiple pieces of sheet-shaped material are mounted, or may simply be a stack of sheet-shaped material. Alternatively, the material input station may be a previous station, such as a work station, in a production line;
collecting said sheet-shaped material from the material input station, which may be merely a table or support, or a more complicated arrangement, and depositing the sheet-shaped material at a work station by means of a robot movable on or about at least one axis, i.e. is a Cartesian, polar, or combined Cartesian and polar robot;
collecting an adhesive applicator from an adhesive applicator rest station by means of the robot;
applying adhesive from said adhesive applicator to the sheet-shaped material deposited at said work station, particularly to the top side of the sheet-shaped material;
returning said adhesive applicator to the adhesive applicator rest station by means of the robot.

In consequence, the same robot is utilised for both collecting and positioning the sheet-shaped material, and for applying adhesive thereto, without requiring that an adhesive applicator be integrated into the robot, or to be permanently attached thereto. Thus, extensive and complicated hoses etc which may become tangled in the robot are no longer needed, and the risk of adhesive dripping from the adhesive applicator is limited to the area between the adhesive applicator rest station and the work station rather than to the entire area of movement of the robot.

In an embodiment of the method, a further piece of sheet-shaped material is collected by the robot from said at least one material input station (i.e. the same material input station or a different material input station) and is deposited on top of the already deposited sheet-shaped material at said work station.

In an embodiment of the method, the laminated structures are building integrated photovoltaics, also known as Structurally Integrated Solar Building Elements, comprising a photovoltaic panel and at least one structural element.

In an embodiment of the method, the sheet-shaped material comprises a photovoltaic panel and at least one structural element.

### BRIEF DESCRIPTION OF THE DRAWINGS

The invention will now be further explained in terms of specific, nonlimiting embodiments illustrated in the figures, which show:

FIG. 1: a schematic illustration of a system according to the invention in plan view;

FIG. 2: a schematic illustration of a system according to the invention in side view;

FIG. 3: a schematic perspective view of a manipulation head of a robot;

FIG. 4: a schematic cross-sectional view of an adhesive applicator and its rest station; and

FIG. 5: a flow diagram of a method according to the invention.

### DETAILED DESCRIPTION

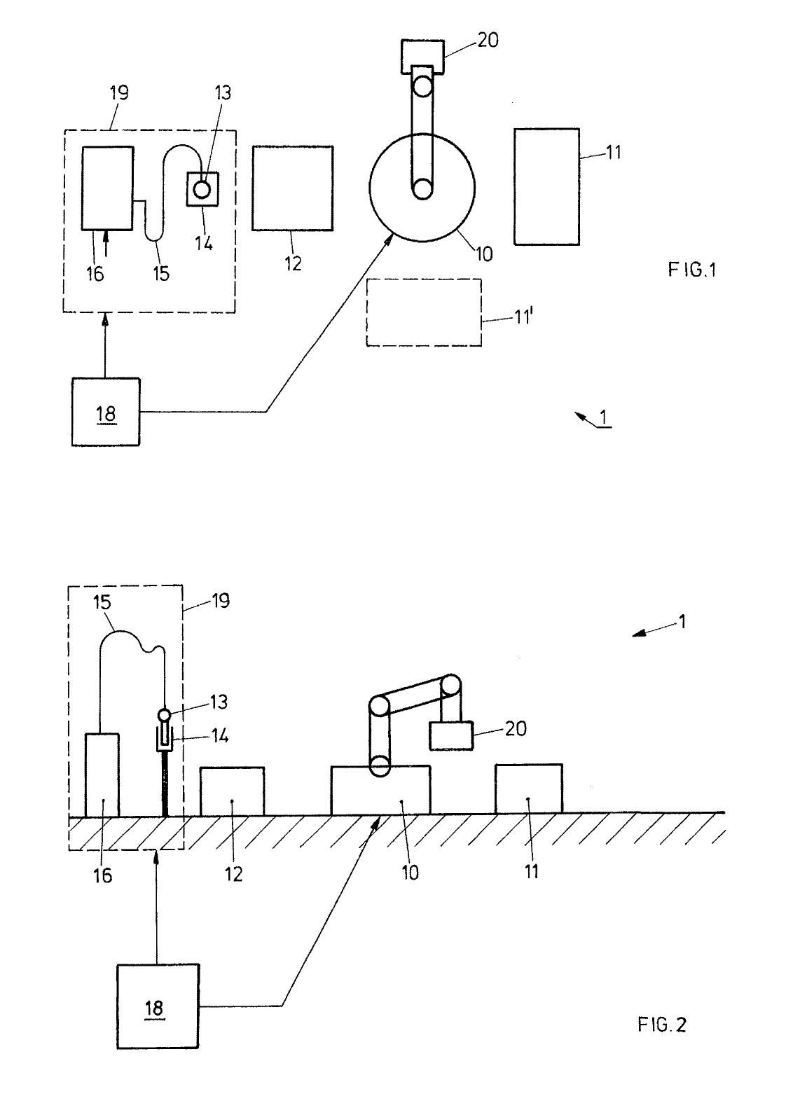

FIG. 1 illustrates schematically in plan view, and FIG. 2 illustrates in side view, a system 1 for assembling laminated structures according to the invention. The system 1 is based around a robot 10 which may be of any convenient type, i.e. polar, Cartesian, or any combination thereof, movable on or around at least one axis. The system may be easily adapted to various robot types other and may be easily adapted for integration into an inline production system. At least one material input station 11 is provided, here illustrated as one compulsory material input station 11 illustrated with unbroken lines and one optional material input station 11′ illustrated in dashed lines, arranged to provide sheet-shaped material. Incorporation of further material input stations is also foreseen as may be required by the particular laminated structure being produced. The material input station may comprise racks, conveyors, may be a previous station in a production line, or may be any other convenient arrangement, such as merely a table upon which material is manually provided. A work station 12 is likewise provided, at which the processing of the laminated structure will take place. This processing takes place by at least positioning sheet-shaped material, applying adhesive to the upper surface thereof, and positioning further sheet-shaped material thereupon. Further stations may also be provided, such as a material alignment station.

An adhesive applicator 13 for applying adhesive to the sheet-shaped material is provided, which, when not in use, is situated in an adhesive applicator rest station 14. The adhesive applicator 13 may be a stand-alone unit, or as illustrated in FIGS. 1 and 2 may be connected via a hose 15 to an adhesive reservoir 16, this reservoir being associated with means (not illustrated) for forcing adhesive to the adhesive applicator 13 itself, which may be a pump, a gravity feed, a piston situated in the reservoir, or a source of pressurised gas such as air or nitrogen arranged to provide overpressure in the reservoir above the level of adhesive. The adhesive may be a single-component adhesive or a multicomponent adhesive, as is convenient for the materials being laminated together. Such arrangements are known to the skilled person and need not be described further. In the illustrated case, adhesive applicator, hose 15, and adhesive reservoir 16 constitute an adhesive applicator arrangement 19.

The at least one material input station 11, 11′, the workstation 12, and the adhesive applicator rest station 14 are all at least partially within the area of reach of the robot 10, such that the robot 10 can manipulate the sheet-shaped material and the adhesive applicator 13 by means of its manipulation head 20, described in greater detail below. Control unit 18 controls the robot 10 and the adhesive applicator arrangement 19 so as to assemble the aforementioned laminated structures. Once the structures are assembled, they are removed from the work station 12 either by hand, by the robot 10, or by other mechanical means (not illustrated).

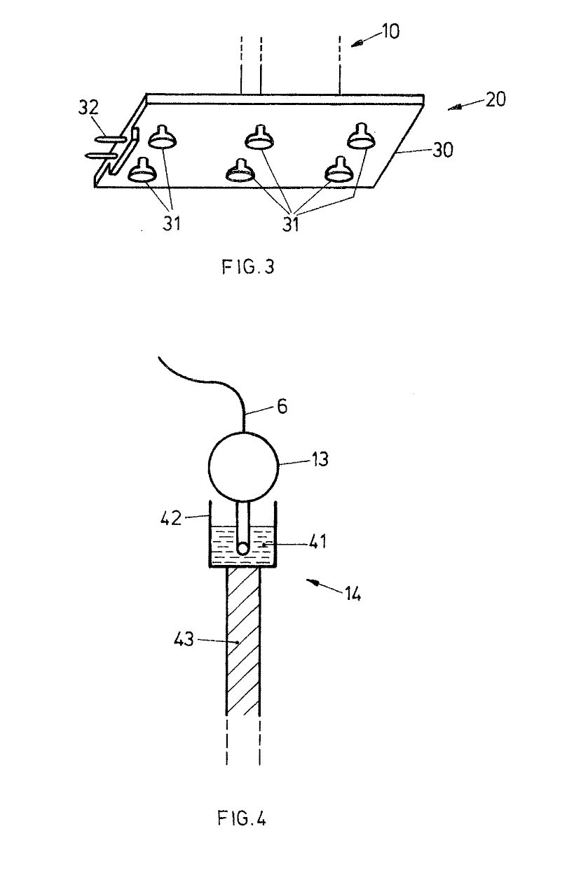

FIG. 3 illustrates schematically a nonlimiting example of a manipulation head 20 of the robot 10. Manipulation head 20 comprises a body 30 provided with a first manipulator comprising a plurality of suction cups 31 arranged for handling sheet-shaped material by application of a negative pressure to the suction cups 31, as is known. In the present example, six suction cups 31 are provided, however any convenient number is possible. Ancillary equipment such as vacuum hoses and vacuum pumps are known to the skilled person and are not illustrated. As an alternative, electromagnets, mechanical gripping means, or other convenient means may be utilised instead. At one end of body 30 is provided a second manipulator, in this example a pair of opposed grippers 32, which may be actuated by solenoid, servo, pneumatically, hydraulically, or by any other convenient means, so as to grip and release adhesive applicator 13. Again, alternatively, electromagnets, suction cups, or other convenient means may be utilised. Adhesive applicator 13 may be provided with features such as grooves, notches, or similar, (not illustrated) for interfacing more accurately and efficiently with the second manipulator. First manipulator and second manipulator, being part of the robot, are controlled by controller 18. In consequence, by means of the manipulation head 20, the robot 10 can manipulate both sheet material and adhesive applicator 13 so as to assemble a laminated structure.

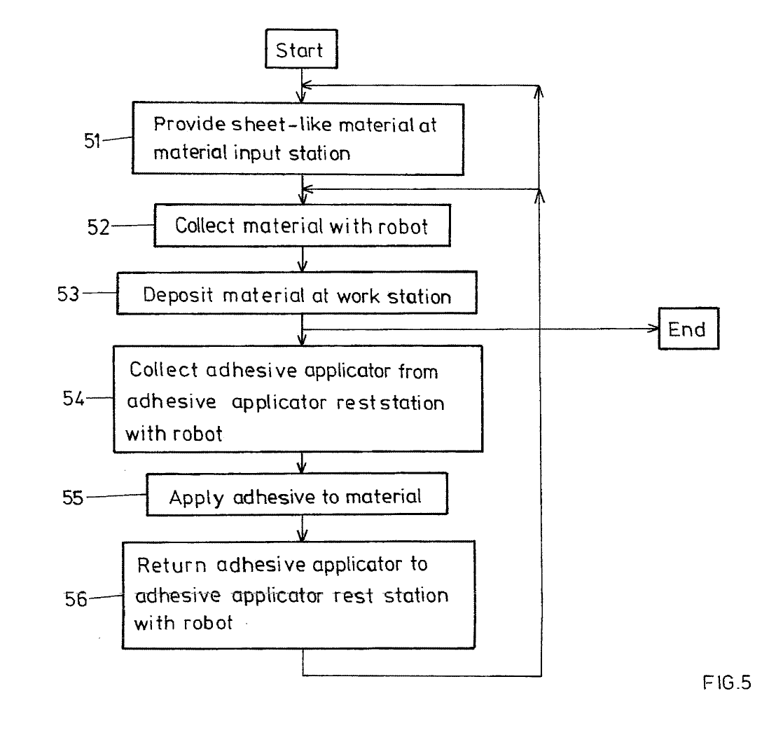

FIG. 4 illustrates a cross-section through adhesive applicator rest station 14 and adhesive applicator 13. It should first be noted that adhesive applicator 13 may be of any convenient type. Adhesive applicator rest station 14 comprises an essentially box-like structure 42 with an open top, into which adhesive applicator 13 may be at least partially inserted when not in use. Essentially box-like structure 42 may be situated upon a stand 43, or otherwise supported as convenient. It should be noted that stand 43 may be fixed or mobile, in which latter case the stand 43 may be moved out of the way of the robot 10 when not required. Depending on the type of adhesive used, it may be advantageous to partially fill the box-like structure 42 with an anti-curing, anti-drying or anti-oxidation liquid agent 41, to prevent adhesive from curing, drying, or oxidising respectively, in which case the box-like structure 42 may be considered as being a liquid agent reservoir.

FIG. 5 illustrates a flow diagram of a method of assembling laminated structures according to the invention. In a first step 51, sheet-shaped material is provided at a material input station 11. In step 52, the robot collects the sheet-shaped material, and in step 53, the robot deposits the sheet-shaped material at the workstation 12. Then, in step 54, the robot collects the adhesive applicator 13 from the adhesive applicator rest station 14, and then applies adhesive to the upper surface of the sheet-shaped material in step 55. Subsequently, in step 56 the robot returns the adhesive applicator 13 to the adhesive applicator rest station 14. At the end of these steps, the first layer of the laminated structure being assembled is ready to receive the second layer of sheet-shaped material. Thus, depending on whether more sheet-shaped material has already been provided at the input station or not, either steps 51, 52 and 53, or just steps 52 and 53 are repeated, after which a two-layer laminated structure has been assembled, the deposition of the sheet-shaped material at the workstation in step 53 taking place in the desired alignment upon the previously-deposited sheet-shaped material. If further layers are required, the method continues again with steps 54-56 and is repeated until the final layer of sheet-shaped material is deposited in step 53 at the workstation on top of the already deposited layers.

Once the desired laminated structure has been assembled, it is removed from the work station 12 either manually, by robot 10, or by other means (not illustrated), for further processing.

As a concrete example of a laminated structure for which this method is particularly suited, but to which the method is not limited, reference is made to the structurally integrated solar building elements described in the applications WO2011/073303 and PCT/EP2012/076109, herein incorporated by reference in their entirety. In broad terms, these structurally integrated solar building elements comprise a photovoltaic panel (constituting a piece of sheet-shaped material) laminated with at least one rigid structural element such as an insulating element, for instance a thermal insulating element e.g. of foam (constituting one or more further pieces of sheet-shaped material). In specific embodiments, such structurally integrated solar building elements comprise a laminated structure of several structural and/or insulating and/or barrier elements mounted upon a photovoltaic module.

Although the invention has been described in terms of specific embodiments, the invention is not to be construed as being limited thereto: the invention is defined solely by the appended claims.

1. System for assembling laminated structures from sheet-shaped material, comprising:
at least one material input station for providing sheet-shaped material;
a work station for processing said sheet-shaped material;
an adhesive applicator arrangement comprising an adhesive applicator;
an adhesive applicator rest station for receiving the adhesive applicator;
a robot movable on or about at least one axis and adapted to collect sheet-shaped material from said material input station and to deposit said sheet-shaped material at said work station;
wherein said robot is further adapted to collect said adhesive applicator from said adhesive applicator rest station, to apply adhesive from said adhesive applicator to said sheet-shaped material deposited at said work station, and to return said adhesive applicator to said adhesive applicator rest station.

2. System according to claim 1, wherein said robot comprises a manipulation head, said manipulation head comprising a first manipulator for releasably holding said sheet-shaped material and a second manipulator for releasably holding said adhesive applicator.

3. System according to claim 2, wherein said first manipulator and said second manipulator each comprise at least one of: at least one gripper, at least one pneumatic suction cup, at least one electromagnet.

4. System according to claim 1, wherein said adhesive applicator arrangement comprises an adhesive reservoir in operative connection with the adhesive applicator and comprises means for forcing adhesive towards the adhesive applicator.

5. System according to claim 4, wherein said means for forcing adhesive towards the adhesive applicator comprise at least one of: a pump, a piston arrangement, a pressurized gas arrangement, a gravity-feed arrangement.

6. System according to claim 1, wherein the adhesive applicator rest station comprises a liquid reservoir for holding a quantity of a liquid agent in contact with at least part of the adhesive applicator when the adhesive applicator is in the adhesive applicator rest station.

7. System according to claim 1, wherein said laminated structures are building integrated photovoltaics comprising a photovoltaic panel and at least one structural element.

8. System according to claim 1, wherein said sheet-shaped material comprises a photovoltaic panel and at least one structural element.

9. Method for assembling laminated structures from sheet-shaped material, the method comprising:
providing sheet-shaped material at at least one material input station;
collecting said sheet-shaped material from said material input station and depositing said sheet-shaped material at a work station by means of a robot movable on or about at least one axis;
collecting an adhesive applicator from an adhesive applicator rest station by means of said robot;
applying adhesive from said adhesive applicator to said sheet-shaped material deposited at said work station;
returning said adhesive applicator to said adhesive applicator rest station by means of said robot.

10. Method according to claim 9, further comprising collecting a further piece of sheet-shaped material from said at least one material input station depositing said sheet-shaped material on top of the already deposited sheet-shaped material at said work station, by means of said robot.

11. Method according to claim 9, wherein said laminated structures are building integrated photovoltaics comprising a photovoltaic panel and at least one structural element.

12. Method according to claim 9. wherein said sheet-shaped material comprises a photovoltaic panel and at least one structural element.
